(19) United States
(12) Patent Application Publication
(10) Pub. No.: US 2020/0067697 A1
(43) Pub. Date: Feb. 27, 2020

(54) METHOD FOR OPERATING A BLOCKCHAIN

(71) Applicant: NEC Laboratories Europe GmbH, Heidelberg (DE)

(72) Inventors: Ivan Puddu, Zurich (CH); Alexandra Dmitrienko, Seeheim-Jugenheim (DE); Ghassan Karame, Heidelberg (DE); Srdjan Capkun, Zurich (CH)

(21) Appl. No.: 16/495,436

(22) PCT Filed: Mar. 22, 2018
(86) PCT No.: PCT/EP2018/057233

§ 371 Date: Sep. 19, 2019

(30) Foreign Application Priority Data
Mar. 22, 2017 (EP) 17162326.7

(51) Int. Cl. H04L 9/06; G06Q 20/38; G06F 16/901

(52) U.S. Cl. CPC H04L 9/0637; H04L 9/0643; G06Q 20/3829; H04L 2209/56; G06F 16/9027; H04L 2209/38; G06Q 20/3827

(57) ABSTRACT

A method operates a blockchain to provide mutable transactions. The blockchain has a sequence of blocks, each block having transaction information, having a transaction, in its data record. A mutability policy is includable in the transaction information, and specifies conditions for changing its transaction. The method includes changing a transaction by: providing, by a sending entity, mutable transaction information comprising the transaction and its mutability policy; verifying the mutable transaction information by the validating entity, and when verified, including the mutable transaction information into a new block; providing, by a mutator entity, mutant transaction information including a reference to the transaction to be mutated and a new transaction to replace the transaction to be mutated; verifying the mutant transaction information by the validating entity, and when validated, replacing the referenced transaction with the new transaction; and setting the transaction as an active transaction providing active information.

### CROSS-REFERENCE TO PRIOR APPLICATIONS

This application is a U.S. National Phase Application under 35 U.S.C. § 371 of International Application No. PCT/EP2018/057233, filed on Mar. 22, 2018, and claims benefit to European Patent Application No. EP 17162326.7, filed on Mar. 22, 2017. The International Application was published in English on Sep. 27, 2018 as WO 2018/172439 under PCT Article 21(2).

### FIELD

The present invention relates to a method for operating a blockchain.

### BACKGROUND

Blockchain is an emerging technology underpinning digital currencies like bitcoin. In particular, it has created interest in other applications that could benefit from decentralization and elimination of trusted third parties (TTP). As a result, other applications using blockchain technology emerged, such as decentralized time-stamping services, distributed file storage, identity management solutions, and smart financial contracts.

Conventional blockchains are append-only distributed and replicated databases, which maintain an ever-growing list of immutable and tamper-resistant data records, e.g., financial transactions and account balances. In contrast to regular databases, blockchains do not rely on centralized trusted third parties, but rather leverage a network of participants, also named validators, who replicate the database and use a group consensus protocol in order to synchronize the ledger. Blockchain validators integrate data records into blocks and chain them together in an append-only manner. The more blocks have been subsequently appended to the data record in question, the harder it gets to remove or modify the record, and not only for an attacker, but also for the legitimate network. This is especially true for blockchains powered by Proof-of-Work POW consensus algorithms, which require validators to invest substantial amount of computational power when building a blockchain in a process called mining. Immutability and tamper-resistance of blockchains stem from their append-only property and are relevant to security of blockchain applications. In a context of digital currency and payments, these properties ensure that all the parties have access to a single history of payment transactions and that such a history cannot be modified. In smart contract systems that additionally store executable code on a blockchain, the underlying blockchain can guarantee that conditions recorded in a smart contract are not to be modified since have been written and published.

While immutability and tamper-resistance of blockchains are essential to provide important security guarantees, the same properties provide other problems. For instance, blockchains do not operate in isolation and external events may aim to annul existing contracts and transactions that exist on the blockchain. Furthermore, the data stored on the blockchain might be such that its distribution is illegal. Moreover, smart contracts may have vulnerabilities and flaws, however their immutability prohibits vulnerability patching. In practice for instance, this has led to severe consequences for Ethereum network and DAO, where the contract was exploited. The problem was overcome by deploying a hard fork—a manual intervention of blockchain operation orchestrated by a notable minority, the team of Ethereum core developers. However, such a solution undermined essential trust assumptions, resulted in splitting of Ethereum into two blockchains (ETH/ETC).

While modifications can easily be introduced into centralized systems by their (trusted) administrators, they are impossible with conventional blockchains. As a matter of fact, conventional blockchains do not provide any mechanisms for removal or modification of data records.

### SUMMARY

An embodiment of the present invention provides a method that operates a blockchain to provide mutable transactions. The blockchain has a sequence of blocks, and each of the blocks has a block header and a data record. A consensus protocol is executed for managing the blockchain by a validating entity. A block of the blocks is appended to a previous block of the blocks, with the block having reference information of the previous block. Corresponding transaction information having a corresponding transaction is includable into the corresponding data record of each of the blocks. A corresponding mutability policy is includable into the corresponding transaction information, the corresponding mutability policy specifying one or more conditions for changing the corresponding transaction. The method includes changing a transaction in the blockchain according to the following steps: providing, by a sending entity, mutable transaction information comprising the transaction and the corresponding mutability policy for the transaction; verifying the mutable transaction information by the validating entity of the blockchain, and in case of a positive verification, including the mutable transaction information into a new block of the blockchain; providing, by a mutator entity, mutant transaction information including a reference to the transaction to be mutated and a new transaction to replace the transaction to be mutated; verifying the mutant transaction information by the validating entity of the blockchain and in case of a positive verification, replacing the referenced transaction with the new transaction in the blockchain; and setting the transaction as an active transaction providing active information.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a conventional blockchain architecture;

FIG. 2 shows a conventional blockchain structure;

FIG. 3 shows a transaction Merkle tree of a conventional blockchain architecture;

FIG. 4 shows steps of a method according to an embodiment of the present invention;

FIG. 5 shows a transaction Merkle tree according to an embodiment of the present invention

FIG. 6 shows a transaction tree according to an embodiment of the present invention;

FIG. 7 shows steps of a method according to an embodiment of the present invention;

FIG. 8 shows a problem of negative account balances;

FIG. 9 shows a solution for the problem of negative account balances according to FIG. 8 according to an embodiment of the present invention;

FIG. 10 shows a justice review system with censorship using a method according to an embodiment of the present invention; and

FIG. 11 shows a hybrid ledger fabric according to an embodiment of the present invention.

### DETAILED DESCRIPTION

Embodiments of the present invention address the problem of overcoming limitations of conventional immutable blockchains, including providing a mutability of a blockchain in without hard forks.

The present invention provides a method for operating a blockchain, the blockchain including a sequence of blocks, wherein the blocks including a block header and a data record, and wherein consensus protocol is executed for managing the blockchain by a validating entity and wherein a block of the blockchain is appended to a previous block with the block including reference information of the previous block and wherein transaction information including a transaction is includable into the data records of a block.

The present invention further provides a system for operating a blockchain, the blockchain including a sequence of blocks, wherein the blocks including a block header and a data record, and wherein consensus protocol is executed for managing the blockchain by a validating entity and wherein a block of the blockchain is appended to a previous block with the block including reference information of the previous block and wherein transaction information including a transaction is includable into the data records of a block.

The present invention further provides a non-transitory computer readable medium storing a program causing a computer to execute a method for operating a blockchain, the blockchain including a sequence of blocks, wherein the blocks including a block header and a data record, and wherein consensus protocol is executed for managing the blockchain by a validating entity and wherein a block of the blockchain is appended to a previous block with the block including reference information of the previous block and wherein transaction information including a transaction is includable into the data records of a block.

In an embodiment the present invention provides a method for operating a blockchain, the blockchain including a sequence of blocks, wherein the blocks including a block header and a data record, and wherein a consensus protocol is executed for managing the blockchain by a validating entity and wherein a block of the blockchain is appended to a previous block, with the block including reference information of the previous block, and wherein transaction information including a transaction is includable into the data record of a block, and wherein a mutability policy is includable into transaction information, the mutability policy specifying one or more conditions for changing a transaction and wherein for changing a transaction in the blockchain, the following steps are performed:
Providing, by a sending entity, mutable transaction information including a transaction and a mutability policy for the transaction,
Verifying the mutable transaction information by a validating entity of the blockchain, and in case of a positive verification including the mutable transaction information into a new block of the blockchain
Providing, by a mutator entity, mutant transaction information including a reference to the transaction to be mutated and a new transaction to replace the transaction to be mutated,
Verifying the mutant transaction information by a validating entity of the blockchain and in case of a positive verification
replacing the referenced transaction with the new transaction in the blockchain, and
setting the transaction as active transaction providing active information.

In other words the present invention provides a method for operating a blockchain. The blockchain includes a sequence of blocks. The blocks in turn are organized with a block header and a data record. A new block of the blockchain is appended to a previous block, with the new block including reference information of the previous block. Transaction information including a transaction may also be included into the data record of a block. The same applies to a mutability policy: The mutability policy is includable into transaction information. A mutability policy specifies one or more conditions for changing a transaction. A consensus protocol is executed by a validating entity for managing the blockchain.

For changing a transaction in the blockchain, first, mutable transaction information including a transaction and a mutability policy for the transaction are provided by a sending entity. The mutable transaction information includes a transaction and a mutability policy for the transaction.

Second, a validating entity of the blockchain verifies the mutable transaction information. Based on the result in case of a positive verification, the mutable transaction information are included into a new block of the blockchain.

Third, mutant transaction information including a reference to the transaction to be mutated and a new transaction to replace the transaction to be mutated is provided by a mutator entity.

Forth, a validating entity of the blockchain, either the same as above or another one, verifies the mutant transaction information. Based on the result in case of a positive verification, the referenced transaction is replaced with the new transaction in the blockchain, and the transaction is set as active transaction providing active information.

In a further embodiment the present invention provides a system for operating a blockchain, the blockchain including a sequence of blocks, wherein the blocks including a block header and a data record, and wherein a consensus protocol is executed for managing the blockchain by a validating entity and wherein a block of the blockchain is appended to a previous block, with the block including reference information of the previous block, and wherein transaction information including a transaction is includable into the data record of a block, and wherein a mutability policy is includable into transaction information, the mutability policy specifying one or more conditions for changing a transaction and including:
a sending entity adapted to provide transaction information including a transaction and a mutability policy for the transaction for changing a transaction in the blockchain,
a validating entity adapted
   to verify the mutable transaction information by a validating entity of the blockchain, and in case of a positive verification to include the mutable transaction information into a new block of the blockchain and
   to verify the mutable transaction information and in case of a positive verification
   to replace the referenced transaction with the new transaction in the blockchain, and
a mutator entity adapted to provide mutant transaction information including a reference to the transaction to be mutated and a new transaction to replace the transaction to be mutated.

In other words, the present invention provides a system for operating a blockchain. The blockchain includes a sequence of blocks. The blocks in turn are organized with a block header and a data record. A new block of the blockchain is appended to a previous block, with the new block including reference information of the previous block. Transaction information including a transaction may also be included into the data record of a block. The same applies to a mutability policy: The mutability policy is includable into transaction information. A mutability policy specifies one or more conditions for changing a transaction. A consensus protocol is executed by a validating entity for managing the blockchain.

The system includes a sending entity adapted to provide transaction information including a transaction and a mutability policy for the transaction for changing a transaction in the blockchain.

The system further includes a validating entity, which verifies the mutable transaction information and, in case of a positive verification, which includes the mutable transaction information into a new block of the blockchain, and which verifies the mutable transaction information. In case of a positive verification the validating entity replaces the referenced transaction with the new transaction in the blockchain.

The system further includes a mutator entity. The mutator entity provides mutant transaction information including a reference to the transaction to be mutated and a new transaction to replace the transaction to be mutated.

In a further embodiment, the present invention provides a non-transitory computer readable medium storing a program causing a computer to execute a method for operating a blockchain, the blockchain including a sequence of blocks, wherein the blocks including a block header and a data record, and wherein a consensus protocol is executed for managing the blockchain by a validating entity and wherein a block of the blockchain is appended to a previous block, with the block including reference information of the previous block, and wherein transaction information including a transaction is includable into the data record of a block, and wherein a mutability policy is includable into transaction information, the mutability policy specifying one or more conditions for changing a transaction and wherein for changing a transaction in the blockchain, the following steps are performed:
Providing, by a sending entity, mutable transaction information including a transaction and a mutability policy for the transaction,
Verifying the mutable transaction information by a validating entity of the blockchain, and in case of a positive verification including the mutable transaction information into a new block of the blockchain
Providing, by a mutator entity, mutant transaction information including a reference to the transaction to be mutated and a new transaction to replace the transaction to be mutated,
Verifying the mutant transaction information by a validating entity of the blockchain and in case of a positive verification
replacing the referenced transaction with the new transaction in the blockchain,
setting the transaction as active transaction providing active information.

At least one embodiment of the present invention may have at least one of the following advantages:
Providing mutability of the blockchain without hard forks and without any disruption.
High flexibility.
Consistency of a blockchain and of transactions even when mutated.

The terms “entity”, “validating entity”, “mutator entity” and “sending entity” refer in particular in the claims, preferably in the specification, each to a device adapted to perform computing like a personal computer, a tablet, a mobile phone, a server, or the like and includes one or more processors having one or more cores and may be connectable to a memory for storing one or more applications which is/are adapted to perform corresponding steps of one or more of the embodiments of the present invention. Any application may be software-based and/or hardware-based installed in the memory on which the processor(s) can work on. The devices, entities or the like may be adapted in such a way that the corresponding steps to be computed are performed in an optimized way. For instance different steps may be performed in parallel with a single processor on different of its cores. Further the entities may be identical forming a single computing device. The device or devices may also be instantiated as a virtual device running on a physical computing resource. Different devices may therefore be executed on the physical computing resource. In other words the above mentioned terms of “entity” are each to be understood as any kind of physical or virtual computing entity or computing entities and may include, but are not limited to the following: an application running on a computer, a microprocessor, a single, dual, quad or octa-core processor or processors or the like or a computer, processor, or the like with a memory. The application, computer or processor may have one or more interfaces, ports or the like for communication with other devices, entities, ports, interfaces or the like.

The term “computer readable medium” may refer to any kind of medium, which can be used together with a computation device or computer and on which information can be stored. The information may be any kind of data which can be read into a memory of a computer. For example the information may include program code for executing with the computer. Examples of a computer readable medium are tapes, CD-ROMs, DVD-ROMs, DVD-RAMs, DVD-RWs, BluRay, DAT, MiniDisk, solid state disks SSD, floppy disks, SD-cards, CF-cards, memory-sticks, USB-sticks, EPROM. EEPROM, quantum storage devices or the like.

The term “encryption key” refers in particular in the claims, preferably in the description, to any kind of information or information parts, which may enable, include, etc. information to be used for encryption of information.

The terms “system”, “device”, etc. refer in particular in the claims, preferably in the specification to one or more devices, computing networks including one or more devices or the like adapted to perform computing, communicating or the like, like a personal computer, a tablet, a mobile phone, a server, or the like e.g. connected to a computational network, the devices including one or more processors having one or more cores and may be connectable to a memory for storing an application which is adapted to perform corresponding steps of one or more of the embodiments of the present invention. Any application may be software-based and/or hardware-based installed in the memory on which the processor(s) can work on. The (computing) devices may be adapted in such a way that the corresponding steps to be computed are performed in an optimized way. For instance different steps may be performed in parallel with a single processor on different of its cores. Further the devices may be identical forming a single computing device. The devices or devices may also be instantiated as a virtual device running on a physical computing resource. Different devices may therefore be executed on the physical computing resource.

The term “transaction” is to be understood in the most general sense and refers in particular in the claims, preferably in the specification to information sent or transmitted into the network, e.g. to nodes connected to the node sending the transaction. The transaction may be provided in form of a message, a data packet or the like and may include information for the recipients of the transaction.

The term “tree structure” or a “tree” refers in particular in the claims, preferably in the specification to an abstract data type or data structure implementing the abstract data type simulating a hierarchical tree structure, with a root value and subtrees of children with a parent node, represented as a set of linked nodes. A tree data structure can be defined recursively (locally) as a collection of nodes—starting at a root node—, where each node is a data structure consisting of a value, together with a list of references to nodes—the “child nodes”—, with the constraints that no reference is duplicated, and none points to the root. Some of the nodes in the tree structure may refer to physical or virtual entities or users or the like.

The term “blockchain” is to be understood, in particular in the claims, preferably in the description as a distributed database maintaining a continuously growing list of data records that are hardened against tampering and revision even by operators of the data storing nodes hosting database. A blockchain includes for example two kinds of records: so-called transactions and so-called blocks. Transactions may be the actual data to be stored in the blockchain and blocks may be records confirming when and in what sequence certain transactions became journaled as a part of the blockchain database. Transactions may be created by participants and blocks may be created by users who may use specialized software or equipment designed specifically to create blocks. The term “blockchain” is e.g. identical to the Bitcoin blockchain as a digital currency was introduced in 2008.

The term “storage location data” is to be understood in its broadest sense, and refers in particular in the claims, preferably in the description to any kind of information or data which enables to find the location(s) of a stored object on a node, server or the like.

The term “network” is to be understood in its broadest sense and refers in particular in the claims, preferably in the specification to at least two entities being connected with each other for communication.

The term “policy” is to be understood in its broadest sense and refers in particular in the claims, preferably in the specification to any kind of data, information, etc. defining certain situations, scenarios, or the like which have to be fulfilled or which must not have to be fulfilled, applied, etc. A policy may be implemented, e.g. using logical comparisons, threshold comparisons with pre-defined parameters, or the like.

The term “mutability” or “mutable” with regard to a “transaction” is to be understood in its broadest sense and refers in particular in the claims, preferably in the specification to any kind of ability to enable an amendment, altering, modification, change, or the like of a transaction stored in the blockchain.

Further features, advantages and further embodiments are disclosed or may become apparent in the following:

A time window may be specified in the mutability policy within which a mutable transaction can be mutated, wherein the time window may be verified by a validating entity of the blockchain. This enhances the flexibility since for instance transactions can only be mutated when the mutant transaction is received within the specified time window. Infinite mutability of mutable transactions is avoided.

The reference information of a previous block may be computed using a chameleon hash function. One of the advantages of a chameleon hash function is, that a transaction can be removed or modified in an easy way without affecting the integrity of the blockchain. Chameleon hash functions are hash function parametrized with the secret trapdoor key. They can provide the same functionality and security guarantees of traditional hash functions, but additionally they enable to efficiently compute any collision given knowledge of the trapdoor key. More in detail a chameleon hash H, is a family of functions (H, tk), where H is the function that computes the hash. The hash is e.g. a function of three variables: pk, m and s, where pk is the public key associated with a specific trapdoor, m the message or data being hashed and S a random value. A chameleon hash H may have the following properties:
Without the knowledge of tk it is infeasible to find two pairs (m,s) and (m′,s′) for which the chameleon hash is the same, i.e. (H(pk,m,s)=H(pk,m′,s′)).
For a randomly chosen s any function in the family will produce the same output distribution independently of m.
For each function in the family, each m and s there exists a collision finding function Col such that: H(pk,m,s)=H(pk,m′,Col (tk,m′,H (pk,m,s)))

The active information may be used to compute the chameleon hash value for the reference information. This enables for example for other validating entities to be able to perform computation on the trapdoor key of the chameleon hash function.

At least the mutable transaction information of each block may be encrypted and wherein for providing mutability of a transaction corresponding decryption information may be provided. This enables to hide alternative data records in an easy and alternative way besides using chameleon hash functions. Preferably deleting transactions are not encrypted because they do not transfer for instance any cryptocurrency and do not include any data. Additional management for encryption of deleting transactions is not necessary thus computing resources are saved.

The encryption may be computed using transaction-specific encryption keys, preferably using AES in CBC mode with a key size having at least 256 bits. This ensures a high level of security. The term “CBC” refers to cipher block chaining mode, the “AES” to the Advanced Encryption Standard.

For verifying integrity of information in a block a Merkle tree may be generated based on the hash values of transactions. This enables to verify the integrity of data records, in particular of transactions since the root of the Merkle tree changes if any of the data records included into the Merkle tree changes.

Transactions may be identified which are dependent from a transaction to be mutated and these dependent transactions may also be mutated when the transaction is mutated. This has the advantage to avoid in particular negative account balances: for instance some transactions that were valid before a mutation of a transaction, could now move more money than available in the balance of their sender at the moment of their emission, and as a consequence become invalid. In other words, mutable transactions may result in negative account balances, once the incoming transaction is replaced with the del(ete) transaction at the time when the account does not have sufficient funds. This might happen if, e.g., the received funds were already spent. When a transaction is mutated, dependent transactions are then also mutated to compensate the missing amount of cryptocurrency in the account.

When a data record of a block includes an account balance, the account balance may be split into a mutable account balance changeable by any transaction and an immutable account balance only changeable by a non-mutable transaction. This further reduces the computational resources since otherwise for each balance each incoming transaction need to be kept track of and outgoing transactions must be related to them losing efficiency.

When a data record of a block includes an account balance, an account policy and/or access policy may be included into set data record and verified by a validating entity of the blockchain. This enhances the security: account policies may for instance specifying access policies with in turn specify access rights. Whenever a transaction is to be executed access rights may be checked.

For storing an account balance in the blockchain, the account balance may be reconstructed from the sequence of transactions amending the initial account balance. This avoids that transaction mutations could invalidate account balances stored in past blocks. Furthermore such invalidated account balances may lead information about mutated transactions. For instance it would be possible to determine the amount of cryptocurrency previously transferred by an inactive transaction by comparing the implicit account balance with the explicit written account balance and already invalidated account balance.

For each mutable transaction a unique binding identifier of the corresponding current active transaction may be stored in a block. This enables an easy way to manage the history of the blockchain.

For storing a history of changes of active mutable transmissions a data structure may be used wherein for each mutable transaction a corresponding mutable transaction identifier and unique identifying information is stored, preferably wherein the unique identifying information may be indirect information from which a hash value of the mutable transaction can be computed. This enables an easy way to keep track of active transmission changes.

There are several ways how to design and further develop the teaching of the present invention in an advantageous way. To this end it is to be referred to the patent claims subordinate to the independent claims on the one hand and to the following explanation of further embodiments of the invention by way of example, illustrated by the figures on the other hand. In connection with the explanation of the further embodiments of the invention by the aid of the figure, generally further embodiments and further developments of the teaching will be explained.

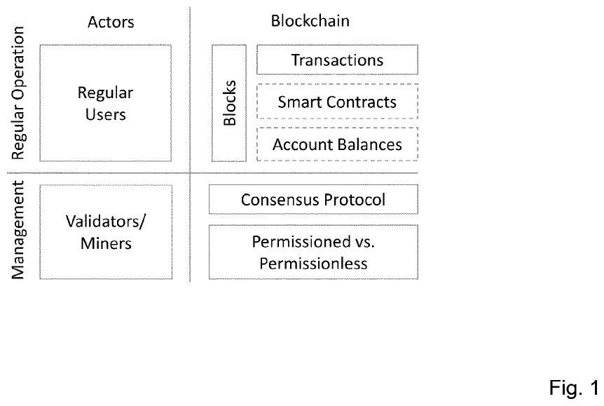

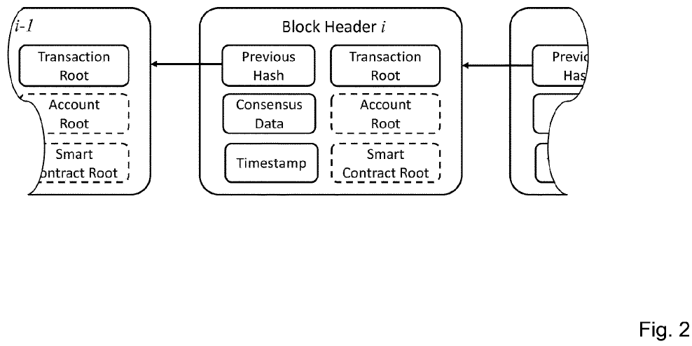

FIG. 1 shows a conventional blockchain architecture and FIG. 2 shows a conventional blockchain structure.

In detail FIG. 1 shows a conventional blockchain architecture. Dashed lines indicate components that are optional. With reference to FIG. 1 two different types of actors in a blockchain system are shown: Regular user and validators. Various types of regular user accounts can be further distinguished, e.g. users can be distinguished into users who make/receive payments and users in form of market-makers—entities providing trading services. Validators may be also referred as miners in particular in blockchains powered by Proof-of-Work consensus algorithms. Actors own accounts, which may be represented as public key pairs identifiable via hashes of corresponding public keys, referred as account addresses. Accounts of regular users are managed by individuals or business entities or can even be managed by computer programs. Validators are system administrators responsible for maintaining a blockchain, who can sometimes also act as regular users, however, regular users do not typically play the role of validators.

The blockchain as already mentioned above is a data structure which serves as a distributed ledger and records information in a network-wide agreed sequence. Information may include data records of different types, such as cryptocurrency transactions, smart contracts and account balances. In the following, different types of data records in more details are described.

The first component of FIG. 1 described here are transactions. Transactions enable a transfer of assets between accounts. While most often used to transfer digital currency, transactions are not limited to financial transfers, but in a general case may also represent the creation or transfer of physical assets, shareholdings, certifications, digital rights, intellectual property or even votes. In particular, transactions can transfer assets between several accounts at once, i.e., one transaction can involve several sender and destination account addresses.

The second and optional component are smart contracts. Smart contracts are computer programs that have been previously created e.g. by regular users or other smart contracts and stored in a blockchain. They typically include code written in some high-level language e.g., Solidity for Ethereum and Go for Hyperledger and data on which smart contracts operate. They can themselves act as regular users: Own regular user accounts holding cryptocurrency send and receive transactions, or even control other smart contracts. Smart contracts are executed by validators—the distributed network of computing nodes—in a replicated manner, which ensures that an agreement encoded in a contract will be enforced when predetermined conditions are met.

The third component, also being optional, are account balances. Account balances indicate how much cryptocurrency is held within the given account. This information can be either included explicitly by integrating the balance of every account into blockchain's state e.g., in Ethereum and Hyperledger, or be present implicitly, e.g., in Bitcoin. Implicit account balances are not explicitly recorded in the blockchain, however their integrity can always be verified by following the sequence of transactions from the very first block in the blockchain, the so-called genesis block.

The forth component are blocks. Information in a blockchain is divided into blocks, where each block may be associated with a fixed time window. Each block includes data records, e.g., transactions and account balances, and block headers. Blocks are chained together by referencing previous blocks via inclusion of the hash of the previous block header into the header of the current block as shown in FIG. 2. Additionally, block headers include a timestamp which corresponds to the time window of the current block, and integrity measurements of all data structures included into the block. Integrity measurements may be constructed by using a Merkle tree.

Further the actors can interact with a blockchain in two modes: Regular operation and management. When compared to databases, the regular mode is equivalent to read/write operations performed by database users. In this mode, regular users and smart contracts can send transactions, which is equivalent to write operations, and query the blockchain, which corresponds to read operations. In a management mode, which can be seen as an equivalent of database administration, the validators integrate transactions sent by regular users and smart contracts into the blockchain.

For managing the blockchain a consensus protocol is executed by validators. It enables them to achieve an agreement on a single history of a blockchain. Examples for a consensus protocols are: based on Proof-of-work (PoW) and/or Proof-of-stake (PoS).

Proof of work procedures are based on cryptographic puzzles which require significant amount of work to find a solution to the puzzle Once found, the solution can easily be verified by other parties. While different PoW functions can be used to build such a cryptographic puzzle preferably a partial hash inversion is used which requires to brute-force a nonce which, when hashed together with the block, would result in a value lower than a given threshold in the following referred as a target value. The target value is a security parameter which regulates the difficulty of solving the puzzle. When applied in a context of blockchain, PoW makes the process of appending a block to the blockchain extremely difficult. For instance, at the current hashrate of the Bitcon network of 1,592,411,223 GH/s, it takes on average 2⁶⁶ hashes to find a valid nonce. Such a nonce is then written in the consensus data field of the block header, so that anyone can verify the solution to the PoW puzzle. The more follow-up blocks are appended to the block, the harder it gets to modify it, as it requires redoing the work for finding the current and all the subsequent blocks. While in a collaborative effort of finding valid blocks a race condition may happen resulting in blockchain forks, these forks are resolved over time, as all the validators work on a longest chain and discard the others. Hence, it may be the that all the validators vote with their computing power to recognize the longest chain and consider its history of data records as valid.

While Proof-of-Work algorithms or procedures require validators to provide a proof of computational resources spent to “mint” a next block of a blockchain, proof-of-stake asks validators to prove ownership of a certain amount of currency, their so-called “stake” in the currency. The more currency is owned by the validator, the higher is the probability for him to be selected to mint the next block. The selection algorithm may be provided with the concept of “coin age”, meaning that the longer period of time the stake have been held by the stakeholder, the higher is the probability to be chosen. Each PoS block must be signed by its creator. The signature of the block represents consensus data stored in the block header.

Further in FIG. 1 one can distinguish permissioned and permissionless blockchains. Permissionless blockchains have open participation and enable anyone to become a validator or send transactions without any restrictions. Examples are Bitcoin and Ethereum blockchains. In contrast, permissioned blockchains are operated by vetted players whose identity need to be verified by an identity service, which binds information about business entities to cryptographic keys. For instance, BankCoin blockchain is operated by banks and ensures that only the banks and the official authorities have access to it.

Blockchains may require only a collision resistant and uniformly distributed hash function and a sUF-CMA signature scheme providing selective unforgeability against a chosen message attack—in order to work properly. However embodiments of the present invention need e.g. a CPA—chosen-plaintext attack—secure encryption scheme or a chameleon hash function. Chameleon hash functions are hash functions parametrized with a secret trapdoor key. They can provide the same functionality and security guarantees of traditional hash functions, but additionally they enable to efficiently compute any collision given knowledge of the trapdoor key. More in detail a chameleon hash H, is a family of functions (H, tk), where H is the function that computes the hash. The hash is e.g. a function of three variables: pk, m and s, where pk is the public key associated with a specific trapdoor, m the message or data being hashed and S a random value. Informally H may have the following properties:
Without the knowledge of tk it is infeasible to find two pairs (m,s) and (m′,s′) for which the chameleon hash is the same, i.e. (H(pk,m,s)=H(pk,m′,s′)).
For a randomly chosen s any function in the family will produce the same output distribution independently of m.
For each function in the family, each m and s there exists a collision finding function Col such that: H(pk,m,s)=H(pk,m′,Col (tk,m′,H (pk,m,s)))

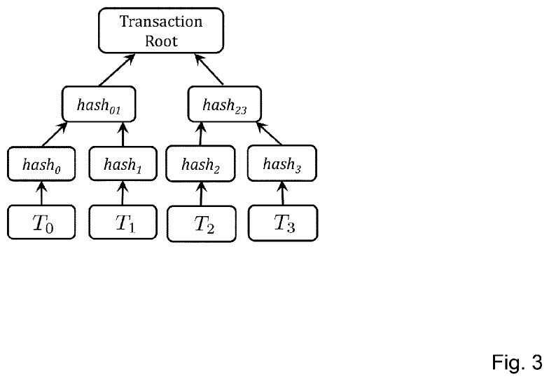

FIG. 3 shows a transaction Merkle tree of a conventional blockchain architecture.

In detail in FIG. 3 a transaction Merkle tree is shown. The Merkle tree is a data structure that organizes data records in a tree, such that all the leaf nodes include the hash of a different data record and all the other nodes of the tree include the hash of the two nodes below them. The Merkle root can then be used to verify integrity of the data records, as it changes if any of the data records included into the tree change. Similar roots may be generated for data structures of other types, such as account balances and smart contracts. Alternatively, different data types can be mixed in a single Merkle tree. For instance, Ethereum blockchains integrate information about smart contracts and account balances in a single tree which root is referred as state root. A further component which is included into the block is consensus data, which is preferably a nonce for PoW consensus algorithms, or a signature when other forms of consensus are used.

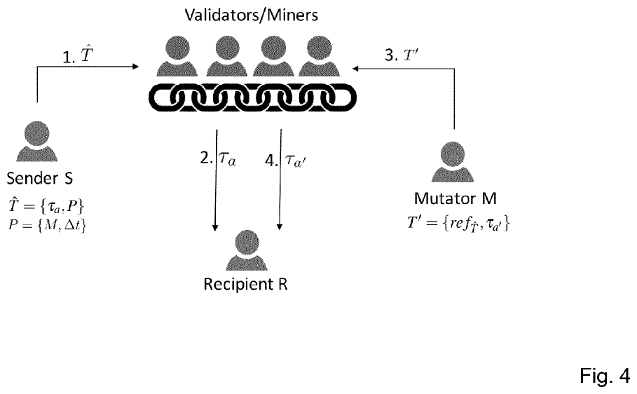

FIG. 4 shows steps of a method according to an embodiment of the present invention.

In detail in FIG. 4 steps for mutating or amending a transaction are shown.

To agree upon a (currently) valid blockchain history, and its capability to hide alternative history versions, preferably mutable transactions are used. These mutable transactions have similar properties to normal transactions as described above in FIG. 1 with the difference that they can be replaced in the future. In particular another type of transaction, a so-called mutant transaction, can be issued and as soon as it gets included into a block it replaces a specified mutable transaction in a previous block. Mutations of transactions are preferably accepted only if pre-specified conditions are met and breaking them invalidates the blockchain. Thus by mining only on valid chains, miners can make sure that invalid mutations of transactions are discarded. Furthermore, mutant transactions not only can be used to modify mutable transaction, but also to remove them from the history of the blockchain. Mutant transactions modify the history of the blockchain, but besides that fact they are handled by the blockchain in the same way as regular transactions, i.e. they are issued by users or smart contracts, verified by validators, and once accepted, they are recorded in the history of the blockchain and can be verified by third parties. All mutations of transactions may be subject to access control policies, which are specified by transaction senders and which are attached to mutable transactions. These access control policies can define who and in which context is allowed to trigger mutations of transactions or add additional versions of data records, and their conditions are verified by validators when mutant transactions are processed. When confidentiality of alternative data records should be provided, for instance, when aiming to prevent distribution of illegal content via the blockchain, it is necessary to prevent access of users to the affected data records. To hide alternative history versions chameleon hashes as described above to store transactions in a block may be used. In this way transaction can be removed or modified without affecting the integrity of the blockchain.

An alternative is to encrypt all the possible history versions, and making decryption keys available only for active data records. Each transaction is then encrypted and the encryption keys are managed by validators. Once an active transaction becomes inactive due to a mutation, its decryption key is not served anymore by the validators. Here transactions are deleted by simply not sharing their decryption key anymore.

Mutable transactions may be represented as pairs (τ, P), where τ is a transaction and P specifies a mutability policy.

A transaction may be one of the following types:
Classic (C): these are conventional transactions signed by a specific sender S addressed to a given recipient R, transferring a certain amount of cryptocurrency from S to R and optionally including a data field.
Deploying (D): transactions of this type are used to deploy smart contracts on a blockchain. They are signed by their sender S and are addressed to all the validators. They include the code to be deployed in their data field.

A mutable transaction is accompanied by a policy P which defines conditions for changing it. In particular, it specifies a party that is allowed to mutate the transaction, which could be the sender S of the transaction τ, its recipient R, or any other regular user or smart contract or a plurality of them. The policy P may also specify a time window Δₜ within which the mutable transaction remains mutable and becomes immutable afterwards. Mutable transactions may co-exist with regular, i.e. legacy transactions, which do not include policies. To distinguish regular and mutable transactions, a regular transaction is denoted with T and \hat{T} for a mutable transaction, respectively in the following.

The transaction component of a mutable transaction \hat{T} can be replaced at a later time with any transaction by issuing a transaction of special type, so-called mutant transaction. Mutant transactions are composed by a pair (ref_{\hat{T}}, {τ, ⊥}), where ref_{\hat{T}} is a reference to a previously issued mutable transaction \hat{T}, τ the new active transaction of \hat{T}, and ⊥ is a distinguished symbol used to signal the deletion of the transaction of \hat{T}. Mutant transactions are denoted as T′.

Mutant transactions specify which mutable transaction \hat{T} they are changing. The information includes here ref_{\hat{T}} a unique identifier that was assigned to \hat{T} when it was included into a block.

An active transaction replaces the current transaction of the mutable transaction specified via ref_{\hat{T}}. The last transaction defined for a mutable transaction \hat{T} is called active transaction of \hat{T}. If no mutant transaction has been issued regarding \hat{T} this is the transaction specified when \hat{T} was issued. For a given \hat{T} there can be at most one active transaction at any given time, meaning that when a mutant transaction changes the active transaction of \hat{T} all the other transactions related to \hat{T} become inactive. A particular case is ⊥: When this is specified in a mutant transaction the current active transaction of \hat{T} becomes inactive, while no new transaction becomes active, effectively deleting the mutable transaction. In the following mutant transactions that delete mutable transactions are referred to as del transactions.

In order to integrate a mutant transaction into the blockchain, validators ensure that the mutability policy P∈\hat{T} is fulfilled and that the new transaction included in the mutant transaction is different from the previous active one. Provided it is allowed by the policies one can issue several mutant transactions for the same \hat{T} and the last one will determine the value of the current active transaction of \hat{T}. In general the mutation of a transaction changes the view the validators have on the transactions recorded in the blockchain. That means it does not change the content of the block including the mutated transaction, it does not change that or other blocks' hash, it does not break the integrity of the blockchain and, as a consequence, does not require to perform again the consensus mechanism the blockchain being based on like PoW for any block, no matter how many blocks where added on top of the one including the mutated transaction. Mutations of transaction are retroactive, therefore once a mutable transaction \hat{T} has been mutated, validators interpret the blockchain's history as the active transaction of T always was the current one. Once mutated, the previous version of a transaction is as good as it never existed, and effects of the new version will manifest in the most recent state of the blockchain.

In FIG. 4 steps of a method of how a mutable transaction \hat{T} can be issued, mutated and received by the recipient are shown. In step 1, the sender S sends the mutable transaction \hat{T}, which defines \hat{T} as an active transaction and specifies that it may be mutated by the mutator M within the time window Δₜ. Once accepted, the active transaction τₐ becomes available to regular users as well as to its recipient R in step 2.

In step 3, a mutator M sends the mutant transaction T′ to mutate the state of \hat{T} to τ_{a′}. If sent within Δₜ time window, it will take effect and replace τₐ with τ_{a′} in the mutable transaction \hat{T}, so that the recipient would now receive τ_{a′} instead of τₐ in step 4.

The structure of blocks according to embodiments of the present invention is based on FIG. 2: It includes values such as a hash of a previous block, consensus data, time stamp, and roots of data structures storing transactions, account balances and/or smart contracts. To manage the history of the blockchain a unique binding identifier of the current active transaction of mutable transactions is recorded. New transaction types, i.e. instant transactions according to embodiments of the present invention are integrated into the Merkle transaction tree along with regular transactions. The structure of the transaction tree is therefore the same as the one depicted in FIG. 3 with the difference that leaf nodes can now be also mutable and mutant transactions. By integrating these mutant transactions in the transaction's tree validators may agree on history changes, but they cannot any hide alternative versions.

Information about active transactions changes is stored in a trie data structure where each (key, value) pair is a node that can be addressed by its hash. A trie data structure is defined in Ethereum being a combination of a Radix tree data structure, also called Patricia tree, and a Merkle tree. Mutable transactions are keyed in this tree by their transaction ID and the value stored for them is some unique identifying information, which could e.g. either be the SHA256 hash of their current active transaction, or values needed to compute their chameleon hash. Depending on the method used to hide alternative history versions the root of the data structure according to embodiments of the present invention might need to be explicitly stored in the block, but otherwise it can simply be derived implicitly from the list of transactions. If this data structure is stored explicitly inside a block it only includes the delta of changes that happened since the last block.

Due to the fact that mutant transactions may modify amount of cryptocurrency transferred between accounts. Account balances are referred to be inferred implicitly by following the sequence of transactions from the genesis block. If account balances would be written explicitly, transaction mutations could invalidate account states stored in past blocks. Furthermore, such invalidated account balances can leak information about mutated transactions. For instance, it would be possible to figure out the amount of cryptocurrency previously transferred by an inactive transaction by comparing the implicit state with the explicitly written and already invalidated account balance.

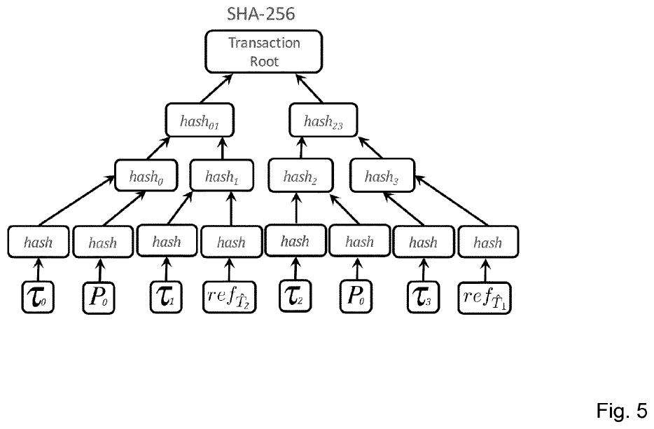

FIG. 5 shows a transaction Merkle tree according to an embodiment of the present invention.

In detail FIG. 5 shows a transaction tree structure when chameleon hashes are used to hide alternative data records. The hashes τ₀, τ₁, τ₂, τ₃ are calculated using a chameleon hash function, while all other one are calculated using SHA-256.

To conceal transactions from the Merkle tree in which they were included without modifying the corresponding root, so that the hash of the block will not change, therefore allowing the same PoW to be valid before and after the change, chameleon hashes are used or every transaction is encrypted.

Chameleon hashes can be used to construct the transaction's Merkle tree, by doing this whenever a transaction needs to be replaced or deleted a collision within the tree can be efficiently computed. This procedure enables to change part of the tree while leaving its root intact. FIG. 5 depicts how chameleon hashes are used to build a transaction's Merkle tree. These changes affect only the way validators construct blocks, but not from a user perspective. Users only need to send the mutable or mutant transaction to validators that then take care of computing the chameleon hash and adding the transaction to the transaction's tree. As described above chameleon hashes H are a function of three values: a public key pk, the message m to hash, and a random value s. Moreover collisions require to find a value s′ such that H(pk,m,s)=H(pk,m′,s′), which can be done efficiently with the knowledge of the trapdoor key tk. While creating the transaction's tree validators need to choose tk, pk, and s in order to compute the chameleon hash. However, since transactions may be potentially changed in the future, other validators need to have the capability to perform some computation on the trapdoor key requiring to explicitly record the information about the current version of a transaction in the blockchain. If such information was not recorded in the blockchain there would be no way to tell whether validators are providing the actual active version of a mutable transaction or simply another version forged by them, as they would be able to compute arbitrary collisions. Therefore the current active version of a transaction in the blockchain is recorded in the trie data structure.

In particular, in this setting, the data structure includes for each transaction, the current random s used to compute its chameleon hash. When users parse the blockchain they use the most recent value s found in the blockchain to compute the chameleon hash of a transaction provided by the miners, and then check if the transaction belongs to the transaction's tree as normal. Whenever a mutation is approved, the value for s of the mutated transaction is updated. Even if everyone can compute collisions, wrongfully modifying a transaction would require to modify the trie data structure that, by construction, is secured in the same way as transactions are in immutable blockchains. Because of this, key management, when using chameleon hashes to hide alternative histories of the blockchain, is simple. Since the trapdoor key can be public a unique trapdoor/public key pair can be chosen to be used to hash every transaction in the chain. However the first s used for a transaction has to be chosen randomly, so that users or validators cannot use the hash of a transaction to encode information. To satisfy this requirement the first s of a transaction has to be the hash of the block preceding the one in which the transactions are saved.

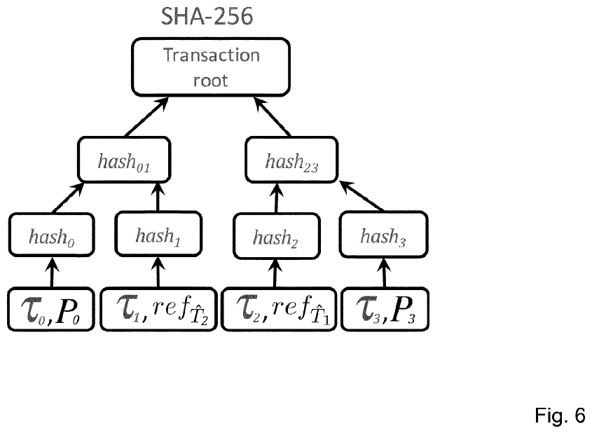

FIG. 6 shows a transaction tree according to an embodiment of the present invention.

In detail FIG. 6 transaction tree structure is shown when encryption is used to swap alternative data records. The hashes are calculated using SHA-256, but the leaves of the tree may only contain encrypted transactions.

The embodiment according to FIG. 6 provides hiding information e.g. alternative data records: All the mutable transactions are encrypted using transaction specific keys. del transactions are preferably not encrypted, because they do not transfer any cryptocurrency and do not include any data, hence, their encryption does not have any benefit, but would result in additional keys to manage.

The embodiment of FIG. 6 does not require the explicit presence of the trie data structure in the blockchain, since it can be computed by validators simply by observing the list of transactions included in the blockchain. As can be seen from FIG. 6 the transaction's tree is a conventional Merkle tree, so no transaction can be “physically” removed from the blockchain, but their removal happens at a logical level. This means that besides updating the view of the validators of the blockchain, whenever a mutation happens in this configuration, validators will start serving the description key of the new active transaction, and stop serving the key for the now inactive transaction. All mutable transactions are here encrypted with transaction specific keys. (Network) validators are then responsible to reveal decryption keys for active transactions, while keeping keys for inactive transactions in secret. In particular validators preferably delete a description key as soon as a new active transaction is declared for a given mutable transaction. In that setting malicious validators can always provide an inactive transaction to users, however this transaction is logically not part of the blockchain anymore. Therefore this is similar to a validator sending information to a user through an out-of-band channel, which can never be prevented. However inappropriate content can always be removed from a valid blockchain.

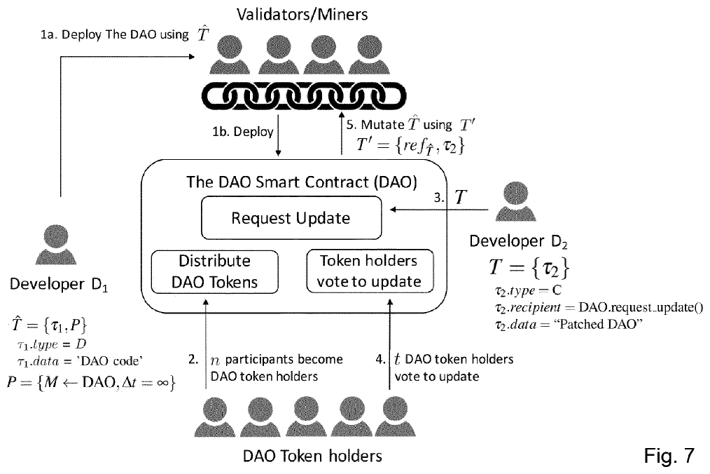

FIG. 7 shows steps of a method according to an embodiment of the present invention.

FIG. 7 shows in detail steps for providing vulnerability of a DAO smart contract.

The DAO takes its name from a Distributed Autonomous Organization. It was designed to receive investments from the participants, and to distribute the cryptocurrency to other Ethereum-based startups and projects. Participants in return for supporting the project receive dividends. The DAO decides which projects will actually get funded using a voting procedure. Voting rights are given to DAO participants by means of a digital token, which is issued in return to an investment made. The DAO has a built-in update mechanism called “newContract”. A new version of DAO is treated in the same way as any other DAO contract proposal—DAO token holders need to vote whether to approve the upgrade or not, and 53% of votes is needed for the update to succeed. However, the internal state of the DAO in the new contract instance cannot be recovered—in particular, an account balance called the “extraBalance” of a few millions worth would be lost if such an upgrade was performed.

First of all, a DAO developer deploys the DAO code on the blockchain using the mutable transaction \hat{T} (step 1a) that specifies a code deploying transaction of type (D) and includes the DAO code. τ₁ is therefore the first active transaction of \hat{T} and the policy P states that the transaction can be mutated only by the DAO contract itself within an unlimited time window. Once the code deployment transaction \hat{T} is processed by the validators, the DAO smart contract is deployed on a blockchain (step 1b). While operating, the contract enrolls n DAO token holders (step 2). Whenever a vulnerability is discovered in the smart contract and the patch is issued, the developer can invoke the DAO smart contract and ask it to approve the patch with transaction T (step 3). T includes the patched code of the DAO contract in its data field. The DAO token holders can then vote in the smart contract to accept or reject the update (step 4). Whenever t votes are collected, the DAO contract issues the mutant transaction T′ (step 5), which makes the code deploying transaction τ₃ with the patched code active. The validators will accept the mutant transaction, as long as it is issued by the legitimate mutator, the DAO contract. As a result, all the transactions which have been ever received by the DAO contract will be re-processed using the new code, resulting in all the stolen funds being returned to the contract.

In contrast to the previously described “newContract” feature of the DAO, the embodiment of FIG. 7 does not require a migration of the contract state to a new instance. Instead, the code of the old instance is replaced with the patched code—eliminating possible errors during state migration. Furthermore, the vulnerability can be protected even after an attack has happened. When patched, the contract internal state would return to the state as if the attack had never happened.

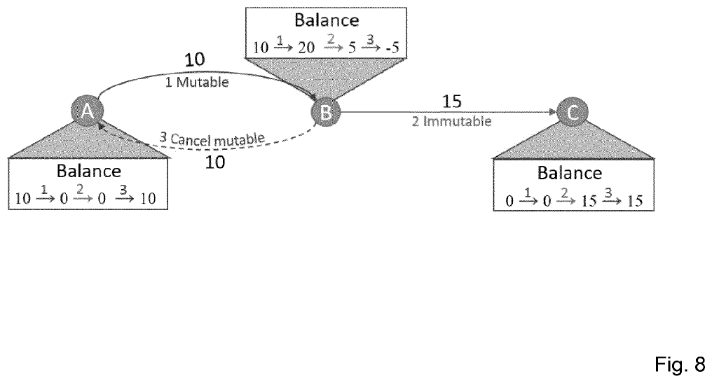

FIG. 8 shows a problem of negative account balances.

As already mentioned some transactions that were valid before a mutation, could now move more money than available in the balance of their sender at the moment of their emission, and as a consequence become invalid. In other words, mutable transactions may result in negative account balances, once the incoming transaction is replaced with the del transaction at the time when the account does not have sufficient funds. This might happen if, e.g., the received funds were already spent.

In FIG. 8 three accounts A, B and C with account balances of 10, 10 and 0, respectively are shown. In a first step, A sends 10 units of cryptocurrency to B in a mutable transaction. As a result, the account balance of A changes from 10 to 0. In a second step, B sends 15 units to C. Third, the first transaction is mutated by replacing the first transaction with del transaction. As a result, the account balance of B becomes −5. This final state, i.e. the negative balance is a problem in particular for permissionless blockchains where accounts are operated anonymously, and hence there is no way to force any entity to compensate the missing funds.

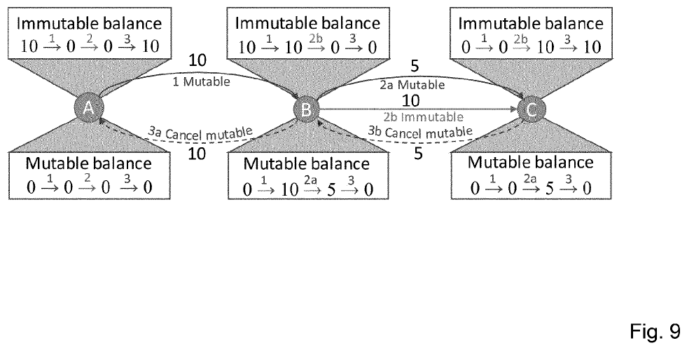

FIG. 9 shows a solution for the problem of negative account balances according to FIG. 8 according to an embodiment of the present invention.

In detail in FIG. 9 to avoid negative balances the missing amount is compensated by cancelling transactions that spent insufficient funds. In particular, they are mutated to del as a side effect of the first mutation. This ensures that only valid transactions are left in the blockchain after a mutation. Further, this results in a balance always equal or greater to 0, not even if there exist another subsequent transaction that causes the balance to be restored. However this can be provided only if transactions always have a time window that makes them immutable at the same time or after the transactions they depend on. If this was not the case and a transaction is mutated to del, its dependent transactions are already immutable and therefore cannot be reverted.

In blockchains with implicit account balances as previously described in connection with FIG. 1, the relevant time window for transactions can be obtained in the following way. In such blockchains preferably each transaction is specified by some “input” transactions and some “output” transactions, with the condition that the output transactions cannot transfer more cryptocurrency than the amount provided with the input transactions. To avoid negative balances, validators must check if all the output transactions have a time window in their policies that makes them immutable at the same time or after all the input transactions they depend on.

In blockchains explicitly storing account balances for each balance each incoming transaction is tracked and each outgoing transaction is related to them. Preferably account balances are split into mutable and immutable parts. Both balances can be spent using mutable transactions, but only immutable balances can be spent using immutable transactions. Any amount of cryptocurrency contained in the mutable balance can be moved in the immutable balance as soon as it becomes immutable as specified in the transaction policy. Validators still require transactions issued from the mutable balance not becoming immutable too early. The first step stays the same as in FIG. 8, namely A uses a mutable transaction to send 10 units of cryptocurrency to B. However, in FIG. 9, B cannot spend 15 units in step 2 using an immutable transaction, because it does not have sufficient funds in its immutable balance. Hence, it splits its transaction into two, one mutable and one immutable, which send 5 and 10 units, respectively, denoted with reference signs 2a and 2b in FIG. 9). When the third step 3 occurs, i.e., the transaction previously sent from A to B is mutated, this event also automatically triggers the mutation of transaction 2a to return missing (and mutable) funds from C to B.

However when enabling to recursively withdraw the money from mutable accounts, the possibility of unexpected currency withdrawal may have negative impact on applications. Therefore account policies may be defined to specify conditions for incoming transactions. For instance, the account holder C on FIG. 9 could specify that his account only receives immutable transactions, or transactions which can be mutated within a specified period of time. Given such account policies, the blockchain validators will reject transactions if the policy of a destination account is not fulfilled. For instance, if the owner of the account C specified that his account can receive only immutable transactions, the transaction sent from B to C at step 2a would be rejected.

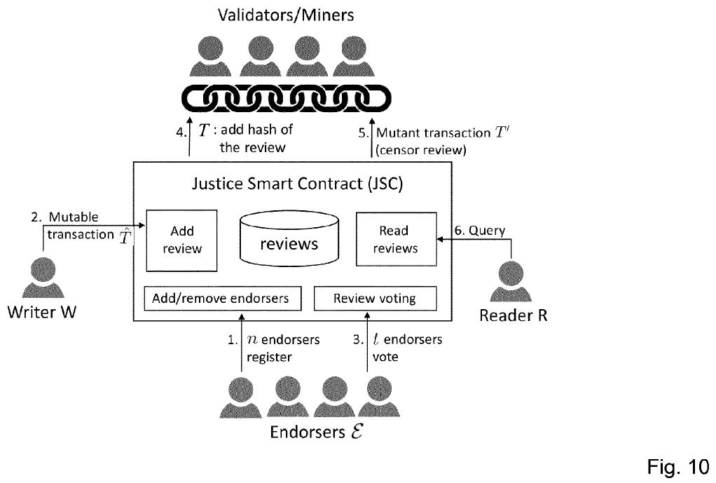

FIG. 10 shows a justice review system with censorship using a method according to an embodiment of the present invention.

In general in FIG. 10 a recommendation system is described which can be preferably used for online services, such as online market places and hotel booking web-sites. For instance, they help customers to get the best product or service for the lowest price and enable service providers to get recognition for good services. Conventional recommendation systems are implemented using a centralized trusted party, that is trusted not to unfairly push their favored products at the top of the recommendation lists. However, a recommendation can be manipulated.

FIG. 10 now describes a blockchain-based collaborative recommendation system, which can be used by service providers like hotels, restaurants and online market places and replace conventional recommendation systems managed by trusted third parties.

The recommendation system according to FIG. 10 fairly treats all the involved parties. The system model of FIG. 10 includes two types of users: (i) Clients and (ii) Endorsers. Clients are regular users of the recommendation system who write and read reviews. Hence, they may be distinguish into readers and writers. In contrast, endorsers are service providers, who collaboratively maintain the recommendation system for rating their services. They are responsible for censoring reviews and filtering out only inappropriate content. Endorsers may be blockchain validators preferably for private permissioned blockchains, or be just regular blockchain users. Both, the clients and the endorsers own regular user accounts on the blockchain and, hence, are capable of sending and receiving transactions. A group of n endorsers is denoted as c in the following. Furthermore, readers and writers are denoted as R and W, respectively.

A so-called justice smart contract JSC implements a number of functions that can be invoked by means of transactions or queries, wherein in contrast to transactions, queries do not change the state of the blockchain. It includes a database of user reviews, which can be written using mutable transactions and read by querying the contract. Further, the JSC itself is able to mutate mutable transactions, whenever the state of the review need to be changed from published to unpublished and vice versa.

After the first deployment, the JSC needs to enroll n endorsers to the system (step 1 in FIG. 10). For instance, in case if the blockchain according to FIG. 10 is instantiated as permissioned, the JSC could validate user permissions. In permission-less blockchains it might be more preferable to keep registration open to any parties who would pay a participation fee (or a stake). Once the contract has enough endorsers in the system, it can accept transactions from review writers. Hence, the writer W sends a mutable transaction \hat{T} with the review to the smart contract (step 2) with a mutable transaction having the following structure: \hat{T}=(τ,P), where τ is a transaction and P defines mutability conditions. In this particular case, τ includes a transaction of classical (C) type and includes the review m in the data field. Furthermore, the policy P states that \hat{T} is extendable and mutable by the JSC contract and for an unlimited period of time.

Once the transaction \hat{T} is received by the smart contract, the review is added to the reviews' database. From now on, endorsers c may vote to censor the review, if they find its content inappropriate (step 3). Whenever the votes by endorsers reach the threshold t, the smart contract issues an immutable transaction T which includes the hash of the review in its data field (step 4), so to record a trace of the message permanently in the blockchain. Next, it mutates the state of the mutable transaction \hat{T} by issuing a mutant transaction T′ and specifying del as new active transaction for \hat{T} (step 5). While this action results in a full review being deleted, its hash value will always stay in the blockchain, because the review messages may have low entropy, preferably a hash function with a random value is used.

To read the reviews, the reader R sends a query request to the JSC (step 6). The smart contract returns the data stored in its review database, including full reviews and hashes of censored reviews. The writer W can also play a role of a reader R and query the JSC. By observing the hash value instead of a review, W can infer information that the review was received, however it does not appear online due to censoring.

If support for review withdrawals by their writers is required, such a functionality can be realized by adding a policy rule into P of \hat{T} to allow the original writer W to activate the del transaction for \hat{T}. This will allow W to issue a mutant transaction to delete \hat{T}. For backward compatibility reasons, preferably communication between clients and the JSC using a web-server as a proxy is provided. This would enable clients to use their regular web-browsers for the communication with the recommendation system. On another hand, if compromised, such a server could manipulate real reviews of clients, e.g., substitute them with bogus ones. However, such attacks are detectable, e.g., clients may independently verify if there is a hash of their review in the JSC in case they do not see their review online. Furthermore, although a proxy web-server is capable of writing and publishing arbitrary bogus reviews, it is equivalent to becoming a review writer who can always write arbitrary reviews. This attack vector, in turn, can be mitigated, by accepting reviews only from clients who can prove they have paid for the service they are going to review, and only can write one review per payment.

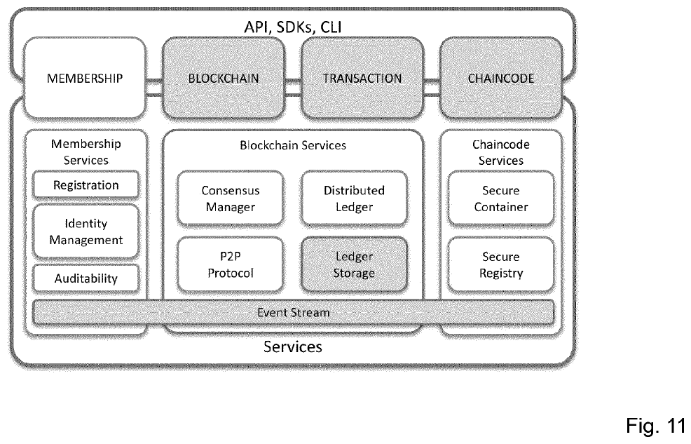

FIG. 11 shows a hybrid ledger fabric according to an embodiment of the present invention.

The Hyperledger Fabric is an open source project, mainly written in the Go programming language, that implements blockchain technology in a modular manner. Various modules can be combined to achieve different properties of the blockchain, which gives the opportunity to blockchain deployers to select the configuration that matches their needs, e.g., to choose various plugins for consensus protocol or decide if the blockchain needs to be permissioned or permissionless. Also, it can be easily extended with new modules. Conventional Hyperledger Fabric does not have any associated cryptocurrency and the only transactions to be supported are from users to smart contracts.

In FIG. 11 the overall architecture of Hyperledger Fabric according to an embodiment of the present invention is shown modules which were extended or modified.

The Transaction module was modified to introduce the notions of mutable and mutant transactions. In particular, two new transaction data structures have been defined: Mutable and Mutant. Since various interfaces of Hyperledger Fabric require a single type of transaction to be given as input, another data structure called InBlockTransaction was created to group all the possible transaction types.

Chaincode is the synonym used for “Smart Contract” in Hyperledger Fabric. Transaction mutations have been made possible by changing the exectransaction.go file in the chaincode module. Two new functions called GetAffecteds and ApplyMutations have been added: GetAffectedTXS returns the list of dependent transactions that are affected by the mutated transaction and, hence, need to be re-processed. ApplyMutations gets such a list as an input and starting from the oldest affected transaction, processes them again in their respective blocks, updating the state of each affected block as the execution goes on. The Hyperledger Fabric's ExecuteTransactions function is executed in particular to process a batch of transactions. According to the embodiment of FIG. 11 this function was modified in such a way that it first selects and executes all the mutant transactions from the given batch, and then calls ApplyMutations to apply changes. Finally, it executes all the other transactions from the batch. In Hyperledger Fabric, smart contracts are run by validators in a docker virtualized environment. For instance they can be written in any language as long as for that language there exists a layer that allows it to be interfaced with the blockchain. The operations that chaincode can perform on the blockchain are defined in the ChaincodeStubInterface.

According to the embodiment of FIG. 11 several new functions to this interface have been added: GetCurrentTXID, GetTransactionByID, and Mutate. GetCurrentTXID allows smart contracts to obtain the ID of the transaction that resulted in their invocation. This can be used when contracts might want to mutate or extend one of the transactions they received: this can be done by calling Mutate and providing the ID of the transaction to mutate as input. Similarly, GetTransactionByID is intended to allow chaincode to get information about transactions related to other smart contracts that they wish to mutate or extend.

Hyperledger Fabric allows to deploy a so called “System Chaincode” which is a smart contract designed to perform blockchain management operations. According to the embodiment of FIG. 11 entities are enabled to associate an account policy Pa to their address. Whenever a transaction set is to be executed, first the relevant access rights are checked in the system chaincode. In the System Chaincode a policy and a mapping to a smart contract identifier is stored. The System Chaincode can express conditions at the granularity of smart contract functions, so that it is possible to, e.g., specify that one function of the smart contract accepts mutable transactions, while another one only deals with immutable ones.

The event stream component is responsible for the communication between various modules. According to the embodiment of FIG. 11 new types of messages are added by modifying the definition of the ChaincodeMessage message type. This message is exchanged between the chaincode and the ledger storage. For instance

it can be used in order to modify the ledger or get some information from it. The new types we introduced in ChaincodeMessage are: MUTATE and OBTAIN_TRANSACTION, which are related to the new functionalities Mutate and GetTransactionByID, respectively.

The ledger storage was enabled to store information about current active transactions. For each mutable transaction issued the current active index and at which block every mutant transaction was created is tracked. This information forms the state of the data structure being stored separately from the chaincode state and its hash is included into the block header.

To manage operations related to the data structure an interface was created, called HashableMutState, with similar properties to the Hyperledger's HashableState. The HashableState interface is implemented by various Hyperledger Fabric's packages that take care of organizing the State of the chaincode into the database. The new packages that implement the HashableMutState interface manage the data structure deltas and allow the ledger to persist the changes to the validator's databases.

Further a procedure GetCurrentDefault in the Ledger class was added to retrieve the current active transaction of a mutable. The procedure works as follows: first the data structure is queried to acquire the identifier of the active transaction of a mutable transaction, then the correct transaction from the blockchain is obtained and a decrypted copy of it is returned.

To summarize every part of the Hyperledger Fabric codebase that was previously dealing with transactions now can handle mutable transactions and has been modified to first get the current active transaction from the Ledger and then perform its operations using the active transaction. The procedure ApplyMutations can request the ledger to start resetting. When this happens, the ledger reverts the current blockchain state to a given block. ApplyMutations then can execute transactions from the current resetting block and when it finishes it can instruct the ledger to apply the changes from all the other transactions in that block. This process continues until ApplyMutations has re-executed all the affected transactions. Before the reset starts the ledger makes a snapshot of the current state of the blockchain, so that, if any irreversible error occurs while the mutations are being applied, the state of the blockchain can be easily rolled-back to the last valid state.

Further, every transaction is indexed so that it can be retrieved by querying it by its ID. In particular, a record is kept that maps transactions to their position in their issuing block. However after a mutation the active transaction of a mutable transactions will be at different block from the one where the mutable transaction was initially declared. Therefore the information stored by addIndeXDataForPersistence was modified in order to maintain, for every transaction ID, a list of blocks that include mutant transactions that reference to it and their position within blocks. The ledger class interfaces itself with the blockchain for multiple operations. Particularly, it can query transactions from it, or retrieve the current height of the blockchain. Since some parts of Hyperledger Fabric need to know the current height of the chain. The ledger is set into reset mode, so that it communicates with the blockchain to provide the current reset status so that the blockchain can always provide the correct value.

The crypto module not being depicted in the Hyperledger Facric architecture of FIG. 11 is also provided with new functions according to embodiments of the present invention in order to encrypt the transaction component of a mutable transaction as discussed above. Transactions are encrypted above by first serializing them and then encrypting the resulting bytes using AES in CBC mode and PKCS7 padding with a 256 bits long key. This process is done clientside. Subsequently the mutable transaction is sent to the validators together with its accompanying key.

When smart contracts mutate themselves, e.g. in vulnerability patching scenario, which verifiability of the blockchain can be provided by recording all the mutations caused by smart contracts in the block where they are originated, without applying them. Afterwards mutations queued in a block are applied at their succeeding block, before the execution of any other transaction starts.

Mutant transactions issued by a smart contract may lead to recursive mutations resulting in endless loops of re-execution. To avoid such loops, any mutations are not applied while the system is in the reset mode. This enables that the execution will always end. Moreover it does not hinder the flexibility of mutations, as they can always be triggered from the current state in order to reach the desired version.

To summarize embodiments of the present invention provide making blockchain history mutable. In particular, a mutable blockchain is provided, which integrates procedures enabling the removal and modification of blockchain data records. The modifications are performed using transactions, so that unauthorized modifications are rejected in the same way as invalid transactions, while legitimate modifications are verifiable by blockchain operators and regular users. Alternative version histories are recorded in the blockchain and it is ensured that only an active history, agreed upon by a consensus, is accessible by users. To hide alternative histories, encryption is used supporting key management enabling confidentiality towards regular users only, or towards both regular users and blockchain operators.

Embodiments of the present invention use the Hyperledger Fabric open source project. Further embodiments patch vulnerabilities in smart contracts without imposing hard forks and without disrupting of blockchain operations.

Even further an embodiment of the present invention provides a collaborative recommendation system with censorship—an application which could not be instantiated using immutable blockchains.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a blockchain, the blockchain comprising a sequence of blocks, each of the blocks comprising a block header and a data record, wherein a consensus protocol is executed for managing the blockchain by a validating entity, wherein a block of the blocks is appended to a previous block of the blocks, with the block comprising reference information of the previous block, wherein corresponding transaction information comprising a corresponding transaction is includable into the corresponding data record of each of the blocks, and wherein a corresponding mutability policy is includable into the corresponding transaction information, the corresponding mutability policy specifying one or more conditions for changing the corresponding transaction, the method comprising changing a transaction in the blockchain according to the following steps:
providing, by a sending entity, mutable transaction information comprising the transaction and the corresponding mutability policy for the transaction,
verifying the mutable transaction information by the validating entity of the blockchain, and in case of a positive verification, including the mutable transaction information into a new block of the blockchain,
providing, by a mutator entity, mutant transaction information including a reference to the transaction to be mutated and a new transaction to replace the transaction to be mutated,
verifying the mutant transaction information by the validating entity of the blockchain and in case of a positive verification, replacing the referenced transaction with the new transaction in the blockchain, and
setting the transaction as an active transaction providing active information.

2. The method according to claim 1, wherein a time window is specified in the mutability policy within which a mutable transaction can be mutated, wherein the time window is verified by the validating entity of the blockchain.

3. The method according to claim 1, wherein the reference information of the previous block is computed using a chameleon hash function.

4. The method according to claim 3, wherein the active information is used to compute a chameleon hash value for the reference information.

5. The method according to claim 1, wherein at least the mutable transaction information of each block is encrypted, and wherein for providing mutability of a transaction, corresponding decryption information is provided.

6. The method of claim 5, wherein the encryption is computed using transaction-specific encryption keys.

7. The method according to claim 3, wherein for verifying the integrity of information in the block, a Merkle tree is generated based on the hash values.

8. The method according to claim 1, wherein transactions are identified which are dependent from a transaction to be mutated and these dependent transactions are also mutated when the transaction is mutated.

9. The method according to claim 1, wherein when the data record of the block comprises an account balance, the account balance being split into a mutable account balance changeable by any transaction and an immutable account balance only changeable by a non-mutable transaction.

10. The method according to claim 1, wherein when the data record of the block comprises an account balance, an account policy and/or an access policy is included into the data record and verified by the validating entity of the blockchain.

11. The method according to claim 1, wherein for storing an account balance in the blockchain, the account balance is reconstructed from a sequence of transactions connecting an initial account balance.

12. The method according to claim 1, wherein for each mutable transaction, a unique binding identifier of a corresponding current active transaction is stored in the block.

13. The method according to claim 12, wherein for storing a history of changes of active mutable transmissions a data structure is used, wherein for each of the active mutable transactions a corresponding mutable transaction identifier and unique identifying information is stored, preferably wherein the unique identifying information is indirect information from which a hash value of the mutable transaction can be computed.

14. A system for operating a blockchain, the blockchain comprising a sequence of blocks, each of the blocks comprising a block header and a data record, wherein a consensus protocol is executed for managing the blockchain by a validating entity, wherein a block of the blocks is appended to a previous block of the blocks, with the block comprising reference information of the previous block, wherein corresponding transaction information comprising a corresponding transaction is includable into the data record of each of the blocks, and wherein a corresponding mutability policy is includable into the corresponding transaction information, the mutability policy specifying one or more conditions for changing a transaction, the system comprising:
a sending entity adapted to provide the corresponding transaction information comprising the transaction and the corresponding mutability policy for the transaction for changing the transaction in the blockchain;
the validating entity adapted to:
verify the corresponding mutable transaction information, and in case of a positive verification, to include the mutable transaction information into a new block of the blockchain, and
verify the mutable transaction information, and in case of a positive verification replace a referenced transaction with the new transaction in the blockchain, and
a mutator entity adapted to provide mutant transaction information including a reference to the transaction to be mutated and the new transaction to replace the transaction to be mutated.

15. A non-transitory computer readable medium storing a program configured to cause a computer to execute a method for operating a blockchain, the blockchain comprising a sequence of blocks, each of the blocks comprise a block header and a data record, and wherein a consensus protocol is executed for managing the blockchain by a validating entity, and wherein a block of the blocks is appended to a previous block of the blocks, with the block comprising reference information of the previous block, and wherein corresponding transaction information comprising a corresponding transaction is includable into the corresponding data record of a each of the blocks, and wherein a corresponding mutability policy is includable into the corresponding transaction information, the corresponding mutability policy specifying one or more conditions for changing the corresponding transaction, the method comprising changing a transaction in the blockchain according to the following steps:
providing, by a sending entity, mutable transaction information comprising the transaction and the mutability policy for the transaction,
verifying the mutable transaction information by the validating entity of the blockchain, and in case of a positive verification, including the mutable transaction information into a new block of the blockchain,
providing, by a mutator entity, mutant transaction information including a reference to the transaction to be mutated and a new transaction to replace the transaction to be mutated,
verifying the mutant transaction information by the validating entity of the blockchain, and in case of a positive verification, replacing the referenced transaction with the new transaction in the blockchain, and
setting the transaction as an active transaction providing active information.
